(19) United States
(12) Patent Application Publication
(10) Pub. No.: US 2025/0113049 A1
(43) Pub. Date: Apr. 3, 2025

(54) INTELLIGENTLY SKIPPING ENCODING OF VIDEO BLOCKS TO REDUCE LATENCY

(71) Applicant: Sony Interactive Entertainment Inc., Tokyo (JP)

(72) Inventor: Hung-Ju Lee, San Mateo, CA (US)

(21) Appl. No.: 18/479,709

(22) Filed: Oct. 2, 2023

(51) Int. Cl. H04N 19/42; A63F 13/358; H04N 19/139; H04N 19/154; H04N 19/172; H04N 19/176; H04N 19/182

(52) U.S. Cl. CPC H04N 19/42; A63F 13/358; H04N 19/154; H04N 19/172; H04N 19/176; H04N 19/182; H04N 19/139

(57) ABSTRACT

Techniques are described for training a machine learning (ML) model to determine, e.g., based on bit rate capacity, whether to encode a frame of video or not. If a frame is dropped according to output of the ML model, the next frame may be encoded at a higher quality than normal using the computing savings gained from dropping the first frame. Compressed domain information may be used to eliminate portions of a frame, but not the complete frame, from encoding.

### FIELD

The present application relates to technically inventive, non-routine solutions that are necessarily rooted in computer technology and that produce concrete technical improvements, and more specifically to intelligently skipping encoding of video blocks to reduce latency.

### BACKGROUND

Computer game play often occurs over a network, in which the game itself may be streamed and multiple gamers who may be remote from each other play the same game. Streaming gaming presents technical challenges related to energy use and network limitations. For example, stringent energy demands may be imposed on network computing that limit the capacity of the network to carry data. Moreover, the sheer volume of data that may sought to be sent over a network can overwhelm network capabilities particularly in the so-called “last mile”. Multiple problems arise from these limitations, including decreased bandwidth and increased latency.

### SUMMARY

As understood herein, data transmission load may be reduced under some conditions by sending less than the standard number of keyframes such as I-frames or portions thereof when network conditions might so dictate.

Accordingly, in a first aspect an apparatus includes at least one processor assembly configured to input at least a first frame of video to at least one machine learning (ML) model, and responsive to output from the ML model indicating that the first frame should not be encoded, not encode the first frame. The processor assembly is configured to, responsive to output from the ML model indicating that the first frame should be encoded, encode the first frame for transmission to a receiver.

The video may include a computer game and the first frame may include a keyframe.

In example embodiments, the processor assembly can be configured to, responsive to output from the ML model indicating that the first frame should be encoded, encode the first frame at a first quality for transmission to a receiver, and responsive to output from the ML model indicating that the first frame should not be encoded, not encode the first frame and encode a second frame with a second quality higher than the first quality.

In example implementations a decoder assembly can include a decoder ML model configured to receive frames from a decoder of the decoder assembly and insert reconstructed frames between frames received from the decoder. The decoder ML model may be trained on a training set comprising sequences of video frames at a first frame rate along with ground truth frames missing from the sequences of frames.

If desired, the processor assembly can be configured to use compressed domain information in video to eliminate portions of frames from encoding.

Indeed and in another aspect, an apparatus includes at least one computer medium that is not a transitory signal and that in turn includes instructions executable by at least one processor assembly to input at least a first frame of video to at least one machine learning (ML) model. The instructions are executable to, responsive to output from the ML model, encode a first region of pixels of the first frame and not encode a second region of pixels of the first frame. The instructions may be executable to transmit the first portion after encoding the first portion and not encode or transmit the second portion to a receiver.

In another aspect, a method includes invoking at least one machine learning (ML) model to process frames of video prior to encoding the frames. The method includes providing the ML model with one or both of pixel domain and/or compressed domain information. The method includes, based at least in part on an output of the ML model, not encoding at least a first frame, and/or encoding only a first pixel region of a second frame and not encoding a second pixel region of the second frame for provision to at least one receiver via a network.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example encoder-decoder system;

FIG. 3 illustrates example training logic in example flow chart format for an encoder side ML model;

FIG. 4 illustrate an example system for intelligently dropping frames from encoding using the ML model trained according to FIG. 3;

FIG. 5 illustrates example training logic in example flow chart format consistent with FIG. 4;

FIG. 6 illustrates example training logic in example flow chart format for a decoder side ML model;

FIG. 7 illustrates an example system for reconstructing dropped frames using the ML model trained according to FIG. 6;

FIG. 8 illustrates alternate example training logic in example flow chart format for an encoder side ML model using compressed domain information;

FIG. 9 illustrates a frame consistent with FIG. 8;

FIG. 10 illustrates alternate example training logic in example flow chart format for a decoder side ML model using compressed domain information; and

FIG. 11 illustrates an example system for reconstructing dropped portions of frames using the ML model trained according to FIG. 10.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

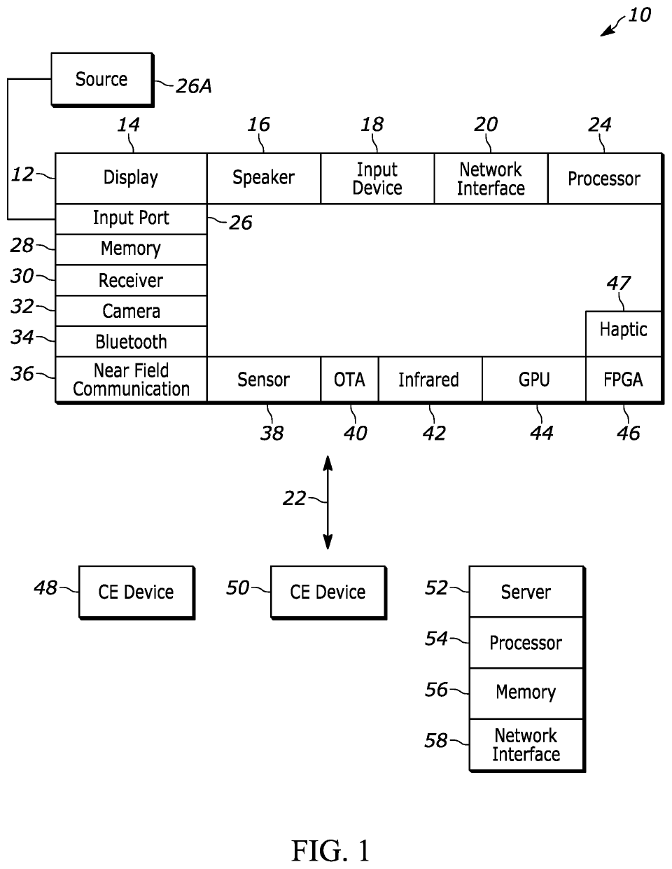

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

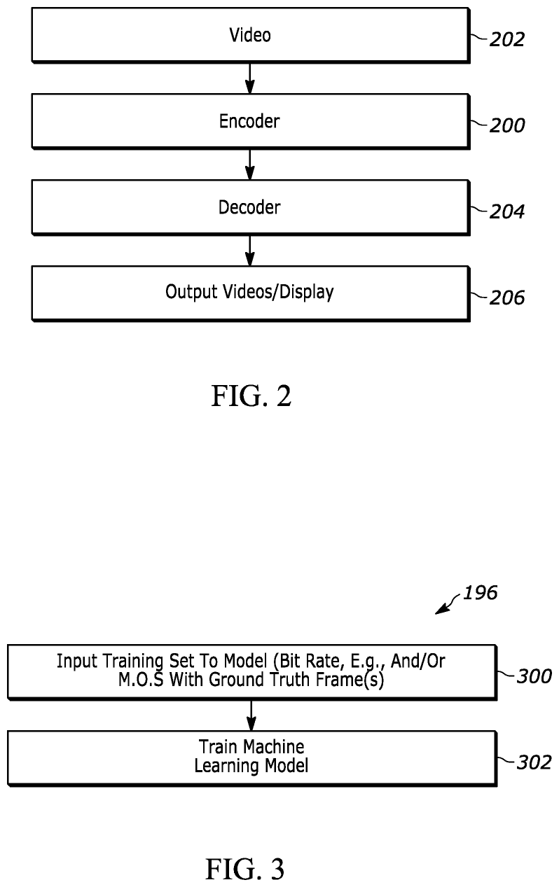

FIG. 2 illustrates a system that includes a video encoder 200 for encoding/compressing videos 202. A video decoder 204 can receive the encoded videos and decode/decompress them into output videos 206.

FIG. 3 illustrates an example technique for training a machine learning (ML) model consistent with disclosure herein. Block 300 indicates that certain data is input to the ML model to train the ML model at block 302. The training data includes plural videos such as computer game videos, each one tagged with a ground truth classification. For example, one video may be tagged as “shooting game” and another may be tagged as “driving game”, while a third video may be tagged as “e-sports”. The videos may be tagged by internal trait classifications such as “high motion”, “low motion”, “large color distribution”, “small color distribution”, and the like.

Moreover, accompanying the videos may be indications of encoding parameters used to encode the videos including bit rate, frame rate, and resolution. Training data may include ground truth indication of whether a frame may be dropped from encoding based on a subjective index representing whether human viewers on average can notice differences (or not) in variations of bit rate and/or frame rate and/or resolution for the video. One such index that may be used is a mean opinion score (MOS), which may be thought of as a subjective video quality metric.

An example goal in training the ML model is to train the model to decide to drop, or not, a frame (or parts thereof) from encoding before a just noticeable difference (JND) threshold at which humans notice a degradation of quality in the video is reached. In this way, power consumption and bandwidth consumption are reduced without noticeable degradation in viewing the video.

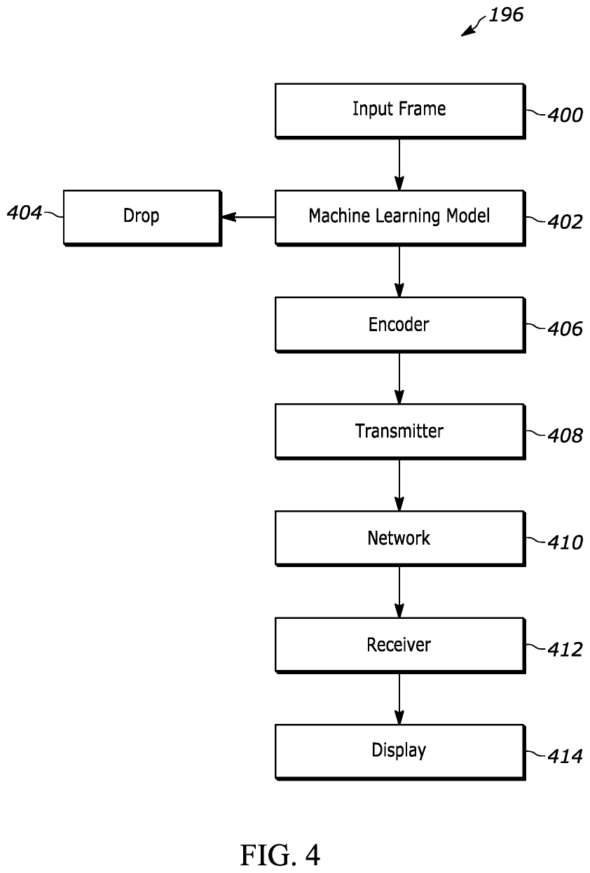

Refer now to FIG. 4. An input frame of video 400 such as a frame of computer game video to be streamed over a network to a recipient gamer system is analyzed by a ML model 402 such as one trained according to FIG. 3 to decide whether to drop (404) the frame from encoding or pass the frame to an encoder 406 to encode the frame. The frames analyzed by the ML model 402 may be keyframes only or all frames (including P-frames) of a video. Thus, given that the ML model 402 will select some frames for elimination from encoding, only some, but not all, of the keyframes of the video may be encoded and provided to a transiter 408 for transmission over a network 410 to a receiver 412 for presentation on a display 414.

Accordingly, when the encoder 406 encounters, for instance, insufficient bit rate capacity, it may invoke the ML model 402 to selectively drop frames from encoding. This can result in a lower and/or variable frame rate. For example, if the input frame rate is 60 FPS, after processing by the ML model the frame rate may be reduced to 48 FPS or 30 FPS, with little discernable difference being noticed by the end user viewing the display 414.

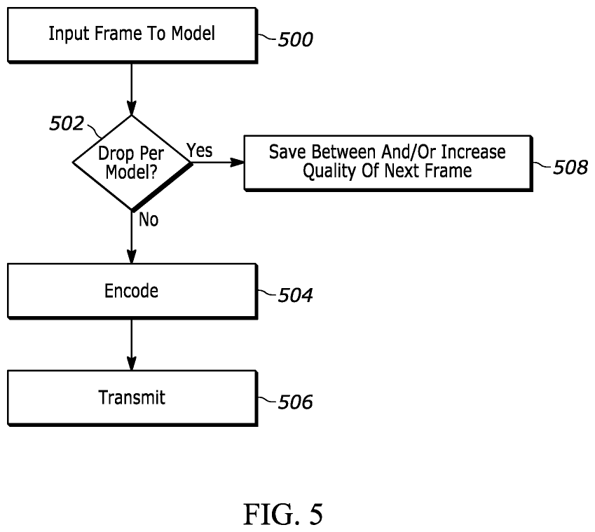

FIG. 5 illustrates logic consistent with FIG. 4. Commencing at state 500, a frame of video such as a keyframe such as an I-frame is input to the ML model, which determines, at state 502, whether the frame should be encoded according to the training of the model. If the frame is to be encoded it is encoded at state 504 and transmitted to a receiver at state 506.

However, if the frame is not to be encoded it is dropped at state 508 and bandwidth thereby saved. Or, the next frame to be encoded may be encoded at a higher quality than it would otherwise be encoded using the savings from dropping a prior frame. For example, a 2K resolution frame may be encoded at 4K resolution using the bandwidth and processing savings from dropping a prior frame.

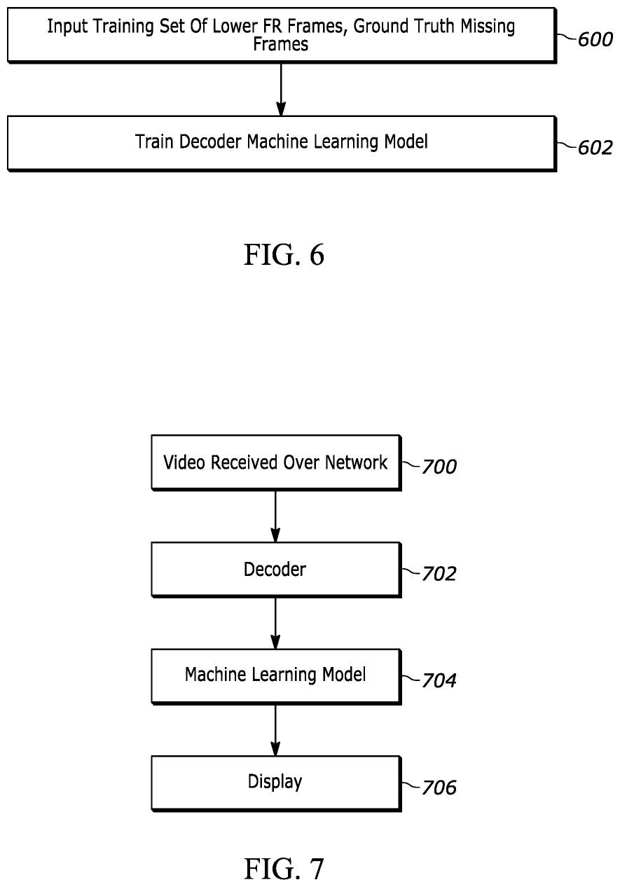

On the receiver side, the decoder can regenerate missing frames using machine learning or simply reduce decoding to be at the received lower frame rate. FIGS. 6 and 7 illustrate the former technique.

A ML model is trained to regenerate frames dropped by the encoder in FIGS. 4 and 5 by inputting a training data set to the model at state 600 in FIG. 6 and training the model at state 602 on the training set. The training set may include sequences of video frames at a relatively low frame rate along with ground truth frames missing from the sequences of missing frames as having been eliminated from encoding consistent with principles herein.

FIG. 7 illustrates that after training the decoder ML model, video 700 such as computer game video may be received and decoded by a decoder 702. The decoded video is passed to the ML model 704 for reconstructing frames dropped by the encoder. The sequence of frames, both those decoded by the decoder 702 and reconstructed and inserted into the video stream using the M model 704, may be presented on a display 706.

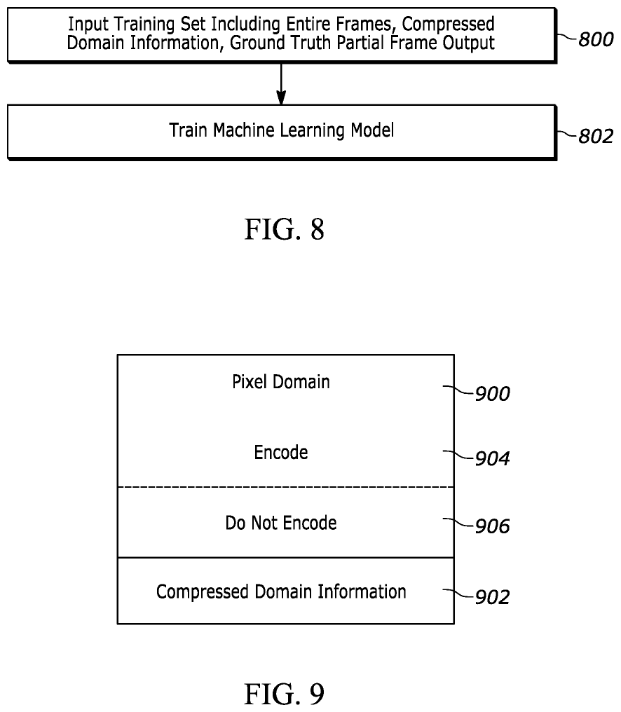

The technique of FIGS. 3-5 for eliminating video content from encoding is pixel-based. Turn now to FIG. 8 for an additional and/or alternate technique of eliminating video content from encoding to save bandwidth using compressed domain information in video such as motions vectors.

Commencing at state 800 a training set of data is input to a ML model to train the model at state 802. The training data may include complete frames of data with accompanying compressed domain information such as motion vectors, and ground truth partial frames that may be output depending on the accompanying compressed domain information such as motion vectors. In this way for instance, parts of a frame characterized by motion vectors indicating little or no motion may be omitted from encoding by the ML model.

FIG. 9 illustrates an example output of the ML model trained according to FIG. 8. Pixel domain information 900 of a frame is received. Based on compressed domain information 902 related to the frame, a first region 904 of the pixel domain of the frame is flagged for encoding while a second region 906 of the pixel domain of the frame is flagged for dropping from encoding. Thus, only a fraction of the frame (less than 100% but greater than 0%) that is given by the number of pixels in the encoded region 904 divided by the sum total pixels in both encoded and non-encoded regions 904, 906 is encoded.

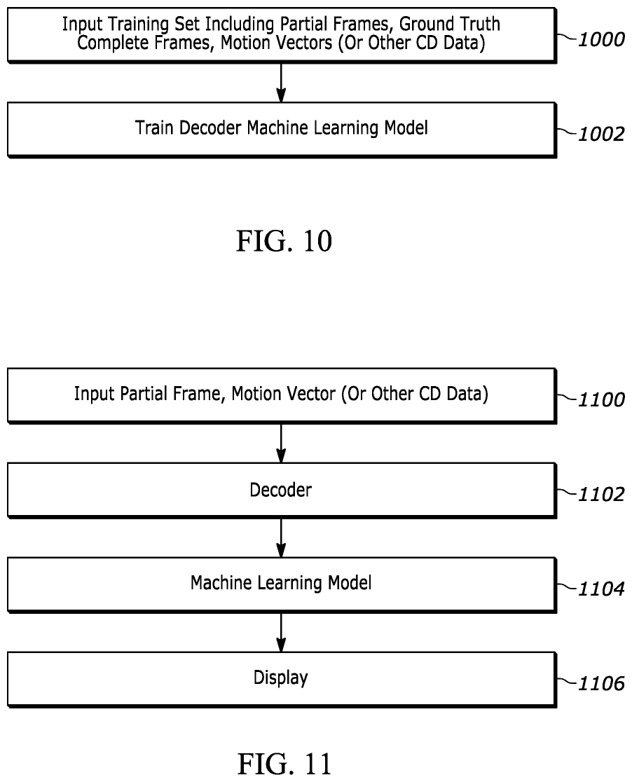

FIGS. 10 and 11 illustrate decoder side features consistent with FIGS. 8 and 9. Commencing at state 1000 a training set of data is input to a ML model to train the model at state 1002. The training data may include incomplete frames of pixel data with accompanying compressed domain information such as motion vectors, and ground truth complete frames that may be output depending on the accompanying compressed domain information. In this way for instance, omitted parts of a frame may be reconstructed after other parts of the frame are decoded and added to the decoded parts using the ML model.

FIG. 11 illustrates that partial frames of video are received at state 1100 and decoded by a decoder 1102. A ML model 1104 trained according to FIG. 10 may reconstruct missing parts of the decoded frames using accompanying compressed domain information according to the training of the ML model, and then both parts of the frame(s) (decoded by the decoder 1102 and reconstructed by the ML model 1104) may be presented on a display 1106 together.

While particular techniques are herein shown and described in detail, it is to be understood that the subject matter which is encompassed by the present application is limited only by the claims.

What is claimed is:

1. An apparatus comprising:
at least one processor assembly configured to:
input at least a first frame of video to at least one machine learning (ML) model;
responsive to output from the ML model indicating that the first frame should not be encoded, not encode the first frame; and
responsive to output from the ML model indicating that the first frame should be encoded, encode the first frame for transmission to a receiver.

2. The apparatus of claim 1, wherein the video comprises at least one computer game.

3. The apparatus of claim 1, wherein the processor assembly is configured to:
responsive to output from the ML model indicating that the first frame should be encoded, encode the first frame at a first quality for transmission to a receiver; and
responsive to output from the ML model indicating that the first frame should not be encoded, not encode the first frame and encode a second frame with a second quality higher than the first quality.

4. The apparatus of claim 1, wherein the first frame comprises a keyframe.

5. The apparatus of claim 1, comprising at least one decoder assembly comprising at least one decoder ML model configured to receive frames from a decoder of the decoder assembly and insert reconstructed frames between frames received from the decoder.

6. The apparatus of claim 5, wherein the decoder ML model is trained on a training set comprising sequences of video frames at a first frame rate along with ground truth frames missing from the sequences of frames.

7. The apparatus of claim 1, wherein the processor assembly is configured to use compressed domain information in video to eliminate portions of frames from encoding.

8. An apparatus comprising:
at least one computer medium that is not a transitory signal and that comprises instructions executable by at least one processor assembly to:
input at least a first frame of video to at least one machine learning (ML) model;
responsive to output from the ML model, encode a first region of pixels of the first frame and not encode a second region of pixels of the first frame; and
transmit the first portion after encoding the first portion and not encode or transmit the second portion to a receiver.

9. The apparatus of claim 8, wherein the video comprises at least one computer game.

10. The apparatus of claim 8, wherein the first frame comprises a keyframe.

11. The apparatus of claim 8, wherein the instructions are executable to:
input, along with the first frame, compressed domain information related to the first frame to the ML model.

12. The apparatus of claim 8, wherein the ML model is trained on a training set comprising complete frames of data with accompanying compressed domain information and ground truth partial frames that may be output depending on the accompanying compressed domain information.

13. The apparatus of claim 8, wherein an amount of the first frame that is encoded equals a number of pixels in the first region divided by a sum total pixels in both the first and second regions, each region comprising at least one pixel.

14. The apparatus of claim 8, comprising at least one decoder assembly configured to:
receive the first region of the first frame;
decode the first region;
reconstruct the second region; and
present the first and second regions together on at least one display.

15. The apparatus of claim 14, wherein the decoder assembly comprises at least one decoder ML model to reconstruct the second region, the decoder ML model being trained on a training set comprising incomplete frames of pixel data with accompanying compressed domain information and ground truth complete frames.

16. A method, comprising:
invoking at least one machine learning (ML) model to process frames of video prior to encoding the frames;
providing the ML model with one or both of pixel domain and/or compressed domain information;
based at least in part on an output of the ML model, not encoding at least a first frame, and/or encoding only a first pixel region of a second frame and not encoding a second pixel region of the second frame for provision to at least one receiver via a network.

17. The method of claim 16, comprising:
providing the ML model with pixel domain information;
based at least in part on an output of the ML model, not encoding at least the first frame.

18. The method of claim 16, comprising:
providing the ML model with compressed domain information;
based at least in part on an output of the ML model, encoding only the first pixel region of the second frame and not encoding the second pixel region of the second frame.

19. The method of claim 16, wherein the video comprises computer game video.

20. The method of claim 18, wherein the compressed domain information comprises motion vectors.
